(19) United States
(12) Patent Application Publication
(10) Pub. No.: US 2010/0116805 A1
(43) Pub. Date: May 13, 2010

(54) OVEN

(75) Inventors: Dingwei LIANG, Fujian Province (CN); Xiaorong Zhang, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/617,957

(22) Filed: Nov. 13, 2009

(30) Foreign Application Priority Data
Nov. 13, 2008 (CN) 200820146371.0

(51) Int. Cl. H05B 1/00

(52) U.S. Cl. 219/201

(57) ABSTRACT

The present invention discloses an oven with a spray device, comprising: a main body, a heating chamber used for heating food disposed inside the main body, a spray device used for spraying the vapor into the heating chamber is set on the main body. The spray device comprising: a water tank, a piston, a electromagnetic valve, a spray. unit By controlling of the electromagnetic valve, the spray device can automatically humidify the food.

### TECHNOLOGY FIELD

The present invention relates to one of kitchen appliances, especially to the oven which can produce vapor in the oven and the vapor can be sprayed on the surface of food uniformly.

### BACKGROUND OF THE INVENTION

The oven is a one of kitchen appliances, the shape of the existing oven is usually box-shaped, and a grill chamber is set inside the oven, the grill chamber is used for baking foods, for example, the bread and so on, can also be used to barbecue foods, for example, the meat and so on, can also be used to thaw food, for example, quickly thawing the food frozen in the refrigerator, in order to achieve better conditioning effect to food, the requirement for humidifying food is needed during the conditioning process. The existing humidification method is usually used steam humidifier, for producing steam, the water in the pipes or the tank should be heated, this leads to the structure of humidification system is complicated, and the cost is increased and affect the competitiveness of the product.

### SUMMARY OF THE INVENTION

The purpose of the present invention is to overcome the inadequacy of existing technologies, to provide an oven with a spray device, allowing the oven can produce vapor in the oven and the vapor can be sprayed on the surface of food uniformly, and humidify the food, and has simple structure and low cost characteristics.

The present invention adopts the following technical solution: an oven, comprising: a main body provided with a bottom cover, an outer cover, an upper reflector plate; a heating chamber used for heating food disposed inside the main body; a spray device disposed on said main body, for spraying the vapor into said heating chamber.

Said spray device comprising:

a water tank provided with a water inlet and a water outlet;

a piston provided with a cavity and a piston rod movable within the cavity, wherein said cavity comprising a pistion inlet connected to said water outlet and a pistion outlet discharging the water out of said cavity by the compression of said piston rod;

an electromagnetic valve comprising a push rod corresponding to said piston rod for pushing the piston rod to achieve compression movement;

a spray unit provided with an atomizer installed on the wall of the heating chamber, and connected with said piston outlet.

a one-way valve is mounted on the piston inlet.

a one-way valve is mounted on the piston outlet.

a spring mounted between said piston rod and the front wall of said cavity using for the reset of the compressed piston rod.

Said water tank is fixed inside of the outer cover of the main body.

Said electromagnetic valve, piston are fixed on the bottom cover of the main body.

Said spray unit is fixed on the upper reflector plate of the main body.

Said spray unit provided with a one-way valve inside, the outlet of the one-way valve is connected with the atomizer.

The beneficial effect of the present invention: because a spray device used for spraying the vapor into the heating chamber is set on the main body, and the spray device comprising: a water tank, a piston, a electromagnetic valve, a spray unit, by controlling of the electromagnetic valve, the spray device can automatically humidify the food, and has simple structure and low cost characteristics.

### BRIEF DESCRIPTION OF THE DRAWINGS

The present invention will be further explained with the drawings and the embodiments.

FIG. 1 is a structure view of present invention;

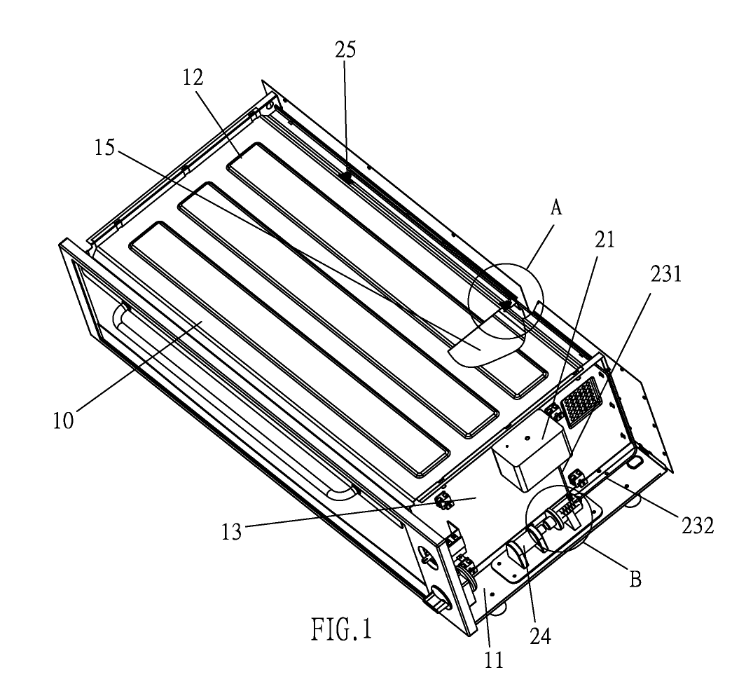

FIG. 2 is an amplificatory view of the A portion of the FIG. 1;

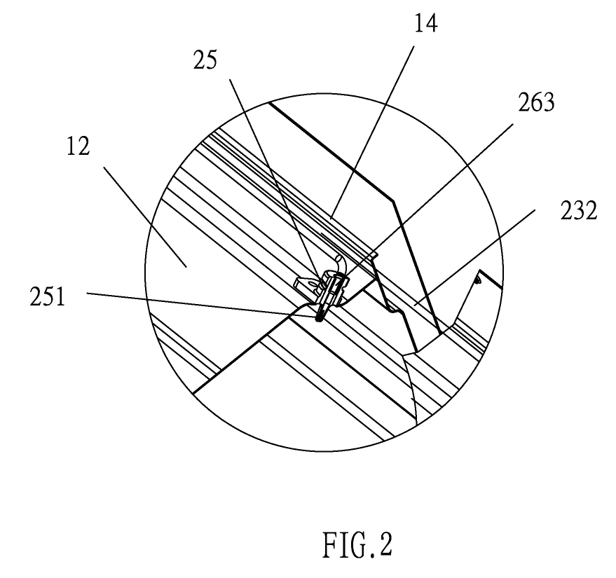

FIG. 3 is an amplificatory view of the B portion of the FIG. 1.

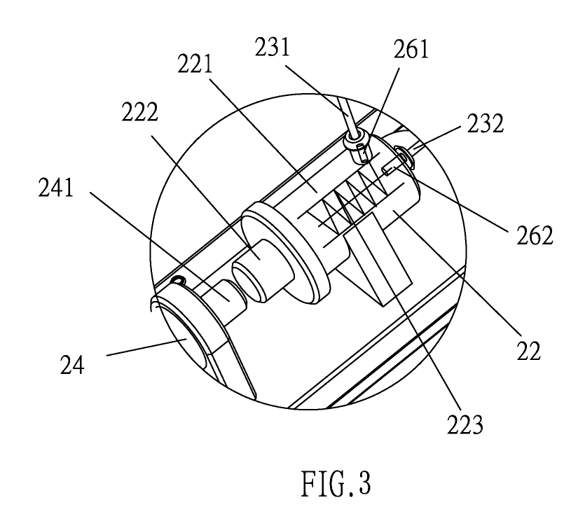

### DESCRIPTION OF THE PREFERRED EMBODIMENTS

Referring to the figs, the oven based on the present invention, comprising: a main body 10 provided with a bottom cover 11, an outer cover, an upper reflector plate 12; a right inner plate 13, a rear reflector plate 14; a heating chamber 15 used for heating food disposed inside the main body; a spray device disposed on said main body, for spraying the vapor into said heating chamber.

Said spray device comprising:

a water tank 21 provided with a water inlet and a water outlet, water can be introduced into the water tank 21 via the water inlet;

a piston 22 provided with a cavity 221 and a piston rod 222 movable within the cavity, wherein said cavity 221 comprising a pistion inlet connected to said water outlet by a tube 231 and a piston outlet discharging the water out of said cavity 221 by the compression of said piston rod 222;

an electromagnetic valve 24 comprising a push rod 241 corresponding to said piston rod 222 for pushing the piston rod 222 to achieve compression movement;

a spray unit 25 provided with an atomizer 251, which can change water into vapor, installed on the wall of said heating chamber, and connected with said piston outlet by a tube 232; The present embodiment adopts two spray units.

a one-way valve 261 is mounted on the piston inlet;

A one-way valve 262 is mounted on the piston outlet;

A spring 223 mounted between said piston rod 222 and the front wall of said cavity 221 using for the reset of the compressed piston rod 222;

Said water tank 21 is fixed inside of the outer cover of the main body;

Said electromagnetic valve 24, piston 22 are fixed on the bottom cover 11 of the main body;

Said spray unit 25 is fixed on the upper reflector plate 12 of the main body.

Said spray unit 25 provided with a one-way valve 263 inside, the outlet of the one-way valve 263 is connected with the atomizer 251.

The oven based on the present invention, a water tank 21 is positioned on the oven, the oven is equipped with a piston 22 and a electromagnetic valve 24, when the electromagnetic valve 24 is electrified, the electromagnetic valve 24 is active, the push rod 241 of the electromagnetic valve pushes the piston rod 222 to achieve compression movement within the cavity 221, when the piston rod 222 moves forwardly and pushes the water in the cavity 221 to the outlet of the cavity 221, the water pushed from the cavity 221 pushes the water positioned in the tube 262 connected between the spray unit 25 and the piston 22 out of the spray unit 25, the water out of the spray unit 25 goes through the atomizer 251, is changed into vapor, the vapor can be sprayed on the surface of food uniformly, achieve the humidification conditioning to food. When the electromagnetic valve 24 is power off, the push rod 241 of the electromagnetic valve does not push the piston rod 222, and the piston rod 222 resets under the force of the spring 223, the negative pressure in the cavity attracts the water in the water tank 21, the power on/off of the electromagnetic valve 24 is to control humidification conditioning to food in the heating chamber 15.

As mentioned above, the described embodiments are to be considered in all respects only as illustrative and no restrictive. All changes which come within the meaning and range of equivalency of the claims are to be embraced with their scope.

What is claimed is:

1. An oven comprising: a main body provided with a bottom cover, an outer cover, an upper reflector plate; an heating chamber used for heating food disposed inside the main body; a spray device disposed on said main body for spraying the vapor into said heating chamber.

2. The oven according to claim 1, wherein said spray device comprising:
a water tank provided with a water inlet and a water outlet;
a piston provided with a cavity and a piston rod movable within the cavity, wherein said cavity comprising an piston inlet connected to said water outlet and a piston outlet discharging the water out of said cavity by the compression of said piston rod;
a electromagnetic valve comprising a push rod corresponding to said piston rod for pushing the piston rod to achieve compression movement;
a spray unit provided with an atomizer installed on the wall of said heating chamber and connected with said piston outlet.

3. The oven according to claim 2, wherein a one-way valve is mounted on the piston inlet.

4. The oven according to claim 2, wherein a one-way valve is mounted on piston outlet.

5. The oven according to claim 2, wherein said cavity further comprising a spring mounted between said piston rod and the front wall of said cavity using for the reset of the compressed piston rod.

6. The oven according to claim 2, wherein said water tank is fixed inside of the outer cover.

7. The oven according to claim 2, wherein said electromagnetic valve and said piston are fixed on said bottom cover.

8. The oven according to claim 2, wherein said spray unit is fixed on the upper reflector plate.

9. The oven according to claim 2, wherein said spray unit further comprising a one-way valve connected with said atomizer.
